(19) United States
(12) Patent Application Publication
(10) Pub. No.: US 2022/0334577 A1
(43) Pub. Date: Oct. 20, 2022

(54) APPARATUS AND METHOD FOR CONNECTING AND MONITORING PROCESSES OF A PRODUCTION MACHINE

(71) Applicant: Schaeffler Technologies AG & Co. KG, Herzogenaurach (DE)

(72) Inventors: Michael Pschyklenk, Röckingen (DE); Martin Stroebel, Markt Erlbach (DE); Martin Schmidt-Korth, Nürnberg (DE)

(73) Assignee: Schaeffler Technologies AG & Co. KG, Herzogenaurach (DE)

(21) Appl. No.: 17/761,640

(22) PCT Filed: Oct. 7, 2020
(86) PCT No.: PCT/DE2020/100872

§ 371 Date: Mar. 18, 2022

(30) Foreign Application Priority Data
Oct. 10, 2019 (DE) 10 2019 127 291.2

(51) Int. Cl. G05B 23/02; G01M 99/00

(52) U.S. Cl. CPC G05B 23/0286; G01M 99/005

(57) ABSTRACT

An apparatus for connecting and monitoring processes of a production machine includes a process monitoring device designed to capture sensor data relating to the production machine and process data relating to the production machine, and a connection device designed to capture control data relating to the production machine. The apparatus is designed to change a hardware function of the apparatus based on the sensor data, the process data, and the control data. The process monitoring device may be designed to carry out data processing for the sensor data and the process data, or the connection device may be designed to carry out data processing of the control data. The apparatus may include a field-programmable logic gate array device designed to change the hardware function.

### CROSS-REFERENCE TO RELATED APPLICATIONS

This application is the United States National Phase of PCT Appln. No. PCT/DE2020/100872 filed Oct. 7, 2020, which claims priority to German Application No. DE102019127291.2 filed Oct. 10, 2019, the entire disclosures of which are incorporated by reference herein.

### TECHNICAL FIELD

The present disclosure relates to an apparatus and a method for connecting and for monitoring, controlling and regulating processes of a production machine and machining processes in the production environment.

### BACKGROUND

To obtain minimum data for basic process monitoring applications from production machines, the production machines are usually equipped with various systems, modules of a remote I/O system, Industrial Internet of Things (IIoT) devices, Configuration Management System (CMS), or the like, which is accompanied by an increase in the cost of the entire production machine.

The performance, handling and connectivity are limited when the various systems interact.

In addition, these systems are often not modularly expandable and allow no or only limited options for subsequent expansion of the functions, for example if additional applications are desired.

An upgrade is usually not economical, especially if the application would require an extension or an exchange or a new design of the hardware components.

If an extension is possible, it is often only with the limitations of the currently installed hardware and usually limited to the respective processing technology. Individual applications in real time can usually only be implemented with great effort on special high-end measuring systems suitable for this purpose.

Various manufacturers are represented on the market with a variety of IIoT devices having different functionalities. The focus here is often primarily on pure connectivity. Systems that can operate individual decentralized data processing at the edge of the network, i.e., have edge computing functionalities, are generally limited to the pure evaluation of machine data or have only very limited options that do not meet the requirements of the highly automated and demanding production processes.

The need to react in real time to ongoing machining processes is also constantly increasing. Adaptive control strategies to optimize cycle times, increase the service life of tools or to avoid phenomena that affect the quality of the workpieces such as chatter, grinding burn, or the formation of corrugations extending round the periphery, are just a few examples of the necessary reactions that must be carried out in real time. In other words, for scenarios that require real-time response

Process monitoring systems available on the market generally offer closed individual functionalities without the possibility of accessing significant, unprocessed data or raw data.

Essential information can thus be lost and existing data cannot be fully used to obtain information.

In addition, IIoT devices offer the possibility to connect machines and access the data thereof or to transmit data from higher-level instances to the machines.

Process monitoring systems acquire sensor data and process data relating to the production machine as well as data from other sources. These are pre-processed, analyzed and the results used to optimize and/or safeguard production processes.

The focus is on process regulation, control, and visualization. In particular, the regulation or control of production machines or entire production systems requires the use of high-performance hardware components that can comply with real-time criteria even during complex calculations.

Connection systems acquire connection data from control components of a production machine or entire production plants and forward them to a higher-level system, such as a cloud or server facility, and vice versa. Many connection systems have edge computing capabilities, i.e., the ability to solve decentralized data processing tasks at the edge of the network, and can prepare the connection data before they are passed on.

### SUMMARY

In addition to the classic connection of production machines or entire production systems and the access to status data and parameters of the same that this enables, it is necessary, due to the constantly growing demands of modern manufacturing processes, to also combine these status data and parameters with external sensor data or process data from various sensors to capture highly dynamic signals such as forces, accelerations, acoustic signals, temperatures, pressures, or the like, and to process and correlate them together.

In this way, the essential parameters for determining anomalies in processes, for guiding control strategies, for the capture of quality features of the workpieces or for determining the wear and tear of components and tools can be determined.

By merging incompletely processed data in a central system for data evaluation, an increase in data quality and an increase in the information content of data can be achieved. This means that no essential information can be lost and existing data can be used entirely to obtain information.

For the processing and correlation of data, in addition to the machine data, highly dynamic sensor data and data made available centrally by a cloud/server device can be used in parallel to determine complex relationships, parameters, trends, or the like.

This is only possible to a limited extent in previous systems, since the available data is usually only processed sequentially and the available data is reduced to the results for the individual systems.

The present disclosure provides an apparatus and a method for connecting and for monitoring processes of a production machine.

According to a first aspect, an apparatus for connecting and for monitoring processes of a production machine is provided. The apparatus includes a process monitoring device which is designed to capture sensor data relating to the production machine and process data relating to the production machine.

Furthermore, the apparatus includes a connection device, which is designed to capture control data relating to the production machine.

The apparatus is designed to change a hardware function of the apparatus on the basis of the sensor data, the process data, and the connection data.

In other words, the system includes a CPU, a reconfigurable hardware part (FPGA), modular and universal sensor interface, a modular fieldbus connector and Ethernet interfaces to the cloud/server and machine connection.

The operating system runs on the CPU, a suitable software-based connection solution for data communication, which can be connected either via Ethernet and/or via a modular fieldbus connector to a system/CNC processing machine, via Ethernet to a higher-level system (server/cloud) and with software applications also running on the CPU.

The software applications can also access NC data in the IPU cycle via the fieldbus connector.

The FPGA is the heart of the system. All time-critical, computationally intensive and real-time significant functions are executed thereon. This technology makes it possible to create real hardware components at runtime and thus to execute real parallel functions as required. The reading of highly dynamic, parallel sensor signals and the pre-processing thereof, such as filtering, is also implemented in the FPGA.

This means that multiple applications can be run simultaneously without violating the hard real-time requirements. At the same time, digital input and output signals are managed by the FPGA.

It is possible to network several systems (in one plant) or several local plants in one line, for example.

The process monitoring device may be designed to carry out data processing for the sensor data relating to the production machine and for the process data relating to the production machine; and/or the connection device may be designed to process the connection data for the connection data.

The apparatus for connecting and for monitoring processes of a production machine may have a field-programmable logic gate array device, which is designed to change a hardware function of the apparatus.

According to an example embodiment, the server device is designed to also process cloud data and server data in addition to the received sensor data, process data, and connection data, in order to change the hardware function of the apparatus.

The server device may be designed to change the hardware function of the apparatus using a trigger. Here the trigger or the trigger signal can be sent from a central cloud system.

A server device may not be part of the apparatus per se, but may be designed as a central external server system/cloud.

According to an example embodiment, the apparatus is designed to change its own hardware function via a trigger.

According to a second aspect, a method for connecting and for monitoring processes of a production machine is provided, having the following steps:

capture of sensor data relating to the production machine and process data relating to the production machine by means of a process monitoring device;

capture of control data relating to the production machine by means of a connection device;

processing of the captured sensor data, process data, and connection data by means of an apparatus; and

changing of a hardware function of the apparatus on the basis of the sensor data, the process data, and the connection data.

The method may also include the following step: carrying out a data processing of the sensor data relating to the production machine and the process data relating to the production machine of the process monitoring device; and/or carrying out a data processing of the connection data from the connection device.

According to a further embodiment, it is provided that the method also includes the following step: changing of a hardware function of the apparatus using a field-programmable logic gate array device on the basis of the sensor data, the process data, and the connection data.

According to an example embodiment, the method also includes the following steps:

receiving of cloud data and server data; and

changing of a hardware function of the apparatus by means of a server device on the basis of the cloud data and server data, which are provided by a cloud/server device.

According to an example embodiment, the method also includes the step of triggering a change in the hardware function of the apparatus by a server device.

### BRIEF DESCRIPTION OF THE DRAWINGS

A better understanding of the disclosure is achieved through the schematic representation of the drawings, which do not have a limiting effect and only describe one possible embodiment.

FIG. 1 shows an apparatus for connecting and monitoring processes of a production machine according to an embodiment;

FIG. 2 shows a flowchart to illustrate steps of a method for connecting and monitoring processes of a production machine according to an embodiment; and

FIG. 3 shows a process diagram to illustrate steps of a method for connecting and monitoring processes of a production machine according to an embodiment.

The figures are merely schematic and not true to scale. In the figures, identical, identically functioning, or similar elements are provided with the same reference symbols.

### DETAILED DESCRIPTION

First, the apparatus according to an example embodiment will be described, and then the advantageous effects of the invention will be described.

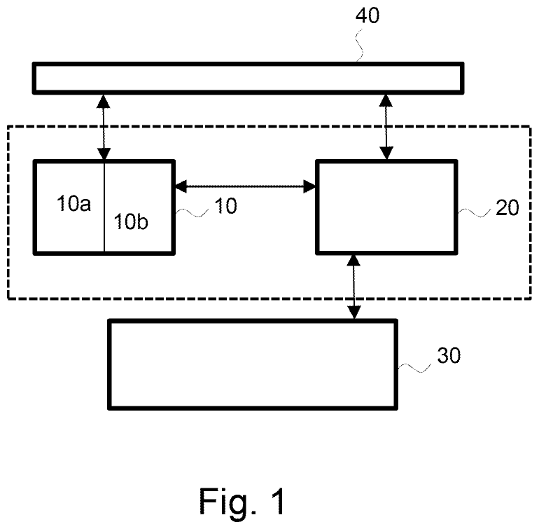

FIG. 1 shows a schematic representation of the apparatus for connecting and monitoring processes of a production machine according to an exemplary embodiment.

The process monitoring device 10 has modular and/or universal sensor interfaces for the capture of highly dynamic signals such as forces, accelerations, acoustic signals, temperatures and/or pressures of the production machine 40, and an Ethernet interface and/or a modular fieldbus connector for data communication with the server device 30.

The connection device 20 optionally has an Ethernet interface and/or a modular fieldbus connector for data communication with the server device 30 or the production machine 40.

The server device 30 optionally has an Ethernet interface and/or a modular fieldbus connector for data communication with the connection device 20.

In the server device 30, incompletely processed data from different sources, which may be sensor data relating to the production machine, process data relating to the production machine of the process monitoring device, control data and connection data from the connection device 20 of the production machine, cloud/server data from other cloud/server devices, are brought together and correlated.

By merging incompletely processed data for data evaluation into a central system, such as server device 30, an increase in data quality and an increase in the information content of data can be achieved.

For the evaluation and correlation of data, in addition to the machine data, highly dynamic sensor data and data made available centrally by a cloud/server device can be used in parallel to determine complex relationships, parameters, trends, and the like. This means that no essential information can be lost and existing data can be used entirely to obtain information.

The server device 30 can change a hardware function of the apparatus using the relationships obtained; the apparatus may have a field-programmable logic gate array device which is designed to change a hardware function of the apparatus, and the server device 30 triggers the change in the hardware.

A field programmable logic gate array device embedded in the process monitor 10 constitutes a major component of the apparatus. All time-critical, computationally intensive and real-time significant functions are executed with this field-programmable logic gate array device. The field-programmable logic gate array device can be used to react to events during the processing process in a time-synchronous manner, wherein the demanding real-time requirements are met.

Adaptive control strategies to optimize cycle times, increase the service life of tools or to avoid phenomena that affect the quality of the workpieces such as chatter, grinding burn, or the formation of corrugations extending round the periphery, are just a few examples of the necessary reactions that must be carried out in real time.

The parallel reading and visualization of highly dynamic sensor signals and the data processing thereof, such as pre-filtering, is also implemented in the field-programmable logic gate array device. This means that several applications can be run simultaneously without violating the hard real-time requirements. At the same time, digital input and output signals are managed by the field programmable logic gate array device.

The visualization does not take place in the FPGA, but alternatively on the local web server or central web servers.

The apparatus can be expanded in a modular manner using the available Ethernet interface and/or the available modular fieldbus connector, which are designed for data communication with other apparatuses for connecting and for monitoring processes of a production machine.

The embedded field-programmable logic gate array facility in the apparatus allows the apparatus to be used easily and flexibly for other applications without having to convert hardware. Thus, the apparatus for connecting and for monitoring processes of a production machine is ideally suited to be used in prototype construction as well as in the mass market.

The integration of a process monitoring device, a connection device and a server device in one apparatus increases IT security against hacker attacks from outside the network, since the integrated systems can be ideally coordinated with one another and communication between the integrated systems is thus better protected.

In addition, simplified handling for the user is achieved since only one device must be configured.

In other words, the apparatus for connecting and for monitoring processes of a production machine is designed to provide a combination of a process monitoring system with a connection system.

The apparatus for connecting and for monitoring processes of a production machine is also designed to provide use of FPGA technology, which enables hardware functions to be changed flexibly.

The apparatus for connecting and for monitoring processes of a production machine is also designed to enable the inclusion of machines, sensor, and server/cloud data for local evaluation of the same for the purposes of process regulation, control, and visualization, and this also synchronously.

The apparatus for connecting and for monitoring processes of a production machine is also designed to carry out a flexible and needs-based reconfiguration of hardware, can be triggered by a central system (server/cloud), and can also be based on requirements determined in the central system or triggered manually.

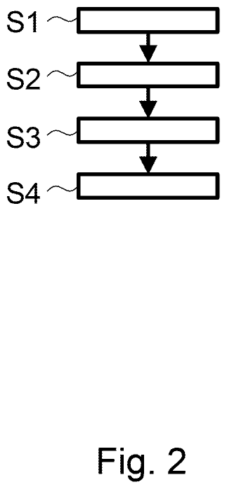

FIG. 2 shows a flow chart to illustrate steps of a method for connecting and monitoring processes of a production machine according to an exemplary embodiment.

In a first step, a capture S1 of the sensor data relating to the production machine 40 and process data relating to the production machine 40 takes place by means of a process monitoring device 10.

In a second step, a capture S2 of the control data relating to the production machine 40 take place by means of a connection device 20.

In a third step, a processing S3 of the captured sensor data, process data, and connection data takes place by means of an apparatus.

In a fourth step, a change S4 of a hardware function of the apparatus takes place on the basis of the sensor data, the process data, and the connection data.

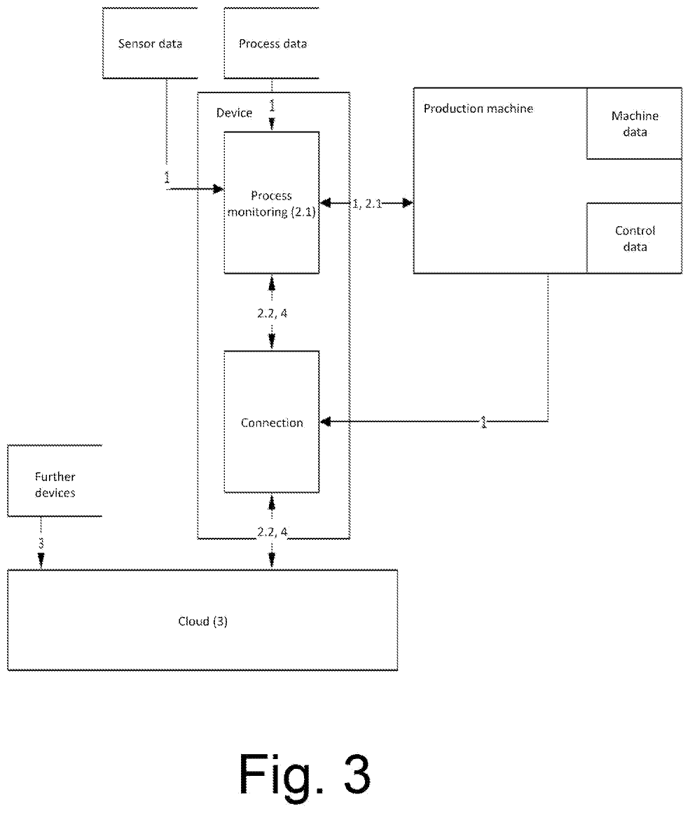

FIG. 3 shows a process diagram to illustrate steps of a method for connecting and monitoring processes of a production machine according to an exemplary embodiment.

The numbered arrows in the example are in ascending chronological order.

1. Capture of all machine data (sensor data, process data, control data, machine data).

2.1 Pre-filtering, analysis of data and, if necessary, initiation of a reaction to the machine.

2.2 Transmission of significant information about the connection device to the cloud.

3. Data from multiple devices is sent to the cloud. There, analyses and correlations are carried out with available information/data.

4. If necessary, initiation of a change of the system's hardware function triggered by the cloud.

However, the present disclosure is not limited to the exemplary embodiment.

### REFERENCE NUMERALS

10 Process monitoring device
20 Connection device
30 Server device
40 Production machine
S1 Capture
S2 Capture
S3 Processing
S4 Change

1.-10. (canceled)

11. An apparatus for connecting and monitoring processes of a production machine, comprising:
a process monitoring device designed to capture sensor data relating to the production machine and process data relating to the production machine; and
a connection device designed to capture control data relating to the production machine, wherein the apparatus is designed to change a hardware function of the apparatus based on the sensor data, the process data, and the control data.

12. The apparatus of claim 11, wherein:
the process monitoring device is designed to carry out data processing for the sensor data and the process data; or
the connection device is designed to carry out data processing of the control data.

13. The apparatus of claim 11, further comprising a field-programmable logic gate array device designed to change the hardware function.

14. The apparatus of claim 11, further comprising a server device designed to process cloud and server data in addition to the sensor data, the process data, and the control data to change the hardware function.

15. The apparatus of claim 14, wherein the server device is designed to change the hardware function via a trigger.

16. A method for connecting and monitoring processes of a production machine, comprising
capturing sensor data relating to the production machine and process data relating to the production machine with a process monitoring device;
capturing control data relating to the production machine with a connection device;
processing the sensor data, the process data, and the control data with an apparatus; and
changing a hardware function of the apparatus based on the sensor data, the process data and the control data.

17. The method of claim 16, further comprising:
carrying out data processing of the sensor data and the process data; or
carrying out data processing of the control data.

18. The method of claim 16, further comprising:
changing the hardware function with a field-programmable logic gate array device based on the sensor data, the process data, and the control data.

19. The method according to one of claim 16, further comprising:
receiving cloud data and server data from a server device; and
changing the hardware function based on the cloud data and the server data.

20. The method of claim 19, further comprising triggering a change in the hardware function with the server device.
